(19) United States
(12) Patent Application Publication
(10) Pub. No.: US 2009/0164192 A1
(43) Pub. Date: Jun. 25, 2009

(54) EFFICIENT MESSAGE REPRESENTATIONS FOR BELIEF PROPAGATION ALGORITHMS

(75) Inventor: Tianli Yu, Schaumburg, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/962,853

(22) Filed: Dec. 21, 2007

(51) Int. Cl. G06F 17/50

(52) U.S. Cl. 703/13

(57) ABSTRACT

A method is provided for determining probabilities of states of a system represented by a model including a plurality of nodes connected by links. Each node represents possible states of a corresponding part of the system and each link represents statistical dependencies between possible states of related nodes. The method includes applying a belief propagation algorithm to estimate a minimum energy of the system defining belief propagation messages. The belief propagation messages are compressed and approximate probabilities of the states of the system are determined from the compressed messages.

### FIELD OF THE INVENTION

The present invention relates generally to modeling probabilistic systems, and more particularly to modeling probabilistic systems using belief propagation in a Markov network.

### BACKGROUND OF THE INVENTION

Many low level vision problems involve assigning a label to each pixel in an image, where the label represents some local quantity such as intensity or disparity. Disparity refers to the difference in location of corresponding features as seen by different viewpoints. Examples of such low level vision problems include image restoration, texture modeling, image labeling, and stereo matching. Other problems that involve assigning a label to each pixel include applications such as interactive photo segmentation and the automatic placement of seams in digital photomontages. Many of these problems can be formulated in the framework of Markov Random Fields (MRFs), which involve Markov networks. In a Markov network, nodes of the network represent the possible states of a part of the system, and links between the nodes represent statistical dependencies between the possible states of those nodes. In the context of low level vision, for example, an image acquired from a scene by a camera may be represented by a Markov network between small neighboring patches, or even pixels, in the acquired image. The problems arising from Markov Random Fields often involves the minimization of an energy function. The energy function generally has two terms: one term penalizes solutions that are inconsistent with the observed data while the other term enforces spatial coherence or smoothness. By construction, these functions vary continuously to gradually increase the penalty for larger label changes between neighboring nodes.

One class of algorithms that have been used to solve energy minimization functions for low level vision problems are belief propagation algorithms, in which certain marginal probabilities are calculated. The marginal probability of a variable represents the probability of that variable, while ignoring the state of any other network variable. The marginal probabilities are referred to as “beliefs.” More formally, a belief is the posterior probability of each possible state of a variable, that is, the state probabilities after considering all the available evidence. Belief propagation is a way of organizing the global computation of marginal beliefs in terms of smaller local computations. Belief propagation algorithms introduce variables such as mᵢⱼ(xⱼ), which can be intuitively understood as a “message” from a node (e.g. pixel) i to a node j about what state node j should be in. The message mᵢⱼ(xⱼ) is a vector with the same dimensionality as xⱼ, with each component being proportional to how likely node i thinks it is that node j will be in the corresponding state. A message directed to node j summarizes all the computations that occur for more remote nodes that feed into that message. Additional details concerning the use of belief propagation algorithms may be found, for example, in P. F. Felzenszwalb and D. P. Huttenlocher, “Efficient Belief Propagation for Early Vision,” Int. J. Comput. Vision, 70(1):41-54, 2006, which is hereby incorporated by reference in its entirety.

One disadvantage of the belief propagation algorithm is the large memory requirement to store all the messages. The total message size scales on the order of O(h*w*l*n), where h and w are the height and width of the MRF, l is the label number, and n is the size of the neighborhood. For instance, in dense stereo reconstruction, a pair of color VGA (640×480) images only needs 1.8 MB of storage. But a BP based stereo algorithm with 100 disparities on this pair needs 1.47 GB to store the floating point messages. This huge message storage requirement not only makes it difficult to fit the algorithm into an embedded system, but also increases the memory bandwidth needed to read/write these arrays.

### BRIEF DESCRIPTION OF THE DRAWINGS

FIG. 1 shows the L1 and L2 smoothness cost functions.

FIG. 2 shows examples of reconstructed messages from predictive coding.

FIG. 3 plots the first three eigenvectors using principle component analysis (PCA) and Aligned PCA obtained from the messages in a stereo image pair of a teddy bear taken from D. Scharstein and R. Szeliski.

FIG. 4 shows an algorithm for computing the envelope point transform (EPT), which preserves the linear time complexity of the messages.

FIG. 5 shows a histogram of the number of envelope points needed to losslessly reconstruct the messages in the stereo image pair employed in FIG. 3.

FIG. 6 shows two examples in which a message can or cannot be losslessly reconstructed using EPT given a fixed length code cₙ

FIG. 7 shows one example of a method for determining the probabilities of states of a system that is represented by a model including a plurality of nodes connected by links.

### DETAILED DESCRIPTION

As detailed below, an efficient message representation technique is provided that is suitable for Belief Propagation (BP) algorithms such as the min-sum/max-product version of belief propagation. Among other advantages, the representations that are employed allow message operations to be performed directly in compressed form, thereby reducing the overhead that would arise if decompression were necessary. In this way storage and bandwidth requirements can be significantly reduced. Efficient message representation is achieved using a compression scheme such as a predictive coding or a transform coding compression scheme. That is, unlike other compression schemes, these compression schemes make use of the particular structure of belief propagation messages to achieve a computationally efficient and accurate message representation. The message representation techniques provided herein will be illustrated in the context of a dense stereo problem. However, these techniques are more generally applicable to belief propagation algorithms that are used to address any of a variety of different low level vision problems, such as those mentioned above, for example.

In the min-sum BP algorithm, the two-step message passing process can be summarized as:

$$\begin{matrix}{H}_{st} ( p ) = {\sum }_{r ∈ N ( s ) x \neq t} {m}_{cs}^{n - 1} ( p ) + {D}_{s} ( p ) & ( 1 ) \\ or & \\ {m}_{st}^{n} ( p ) = {min}_{p} ( {H}_{st} ( p ) + V ( p , q ) ) & ( 2 )\end{matrix}$$

where r, s, t are MRF nodes, p, q are the label indices, N(s) is the set of neighbor nodes of s, mⁿ⁻¹ᵣₛ (p) are the messages passed to node s from its neighboring nodes at time n−1, Ds(p) is the data term of s (the stereo matching cost), Hₛₜ(p) is the aggregated message, and V (p, q) is the smoothness cost parameter (or compatibility function) between two labels. mⁿₛₜ(q) is the message passed from s to t at time n. Eq. (2) is referred to as the minimum convolution, where an original function is modulated by the smoothness cost, and the lower envelope (rather than the sum in the sumproduct algorithm) is computed. To simplify the notation, the subscript “st” will be omitted whenever appropriate.

In some cases the smoothness cost V(p,q) is chosen to be a distance function S(p−q), where

$$S ( x ) = \{ \begin{matrix}\vert x \vert & if \vert x \vert < t \\ t & otherwise\end{matrix}$$

This is usually referred to as the truncated L1 distance function.

In other cases the distance function S(p−q) is chosen to be

$$S ( x ) = \{ \begin{matrix}{x}^{2} & if \vert x \vert < t \\ {t}^{2} & otherwise\end{matrix}$$

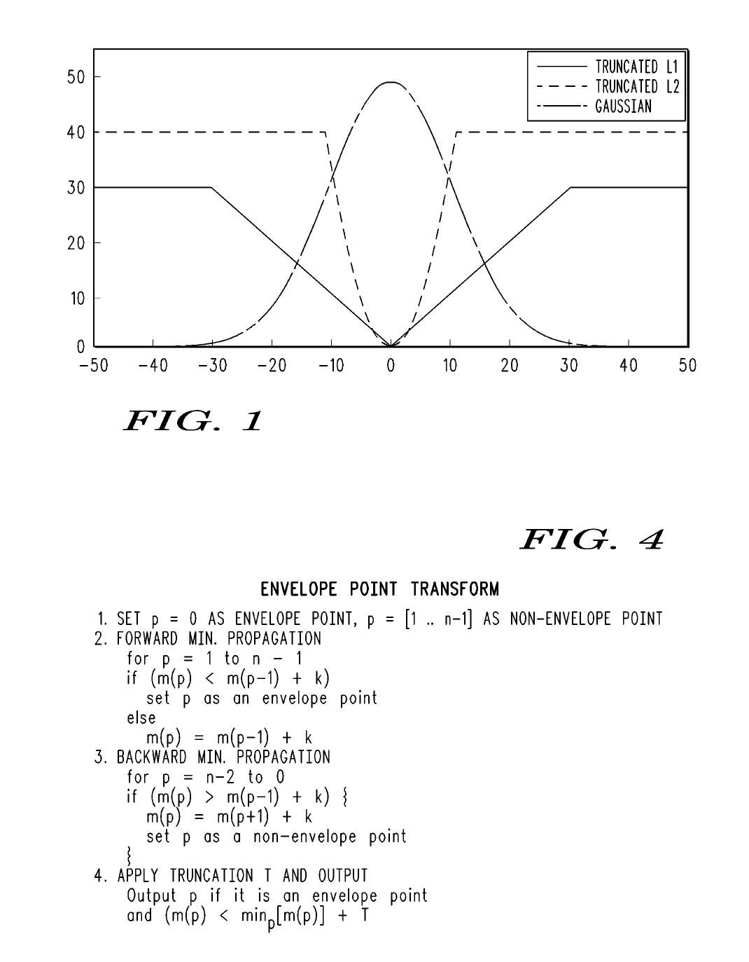

This smoothness cost is usually referred to as the truncated L2 distance function. These smoothness cost functions are shown in FIG. 1.

The general idea of compression is that any data set contains hidden redundancy which can be removed, thus reducing the bandwidth required for the data's storage and transmission. In particular, predictive coding removes the redundancy of a time series or signal by passing the signal through an analysis filter. The output of the filter, termed the residual error signal, has less redundancy than the original signal and can be quantized by a smaller number of bits than the original signal. The residual error signal can then be stored along with the filter coefficients. The original time series or signal can be reconstructed by passing the residual error signal through a synthesis filter.

In the context of belief propagation messages, the use of a predictive coding scheme is based on the assumption that the difference between neighboring message components are small and can be represented using fewer bits than the original message components. In the min-sum BP algorithm, we can show that for the truncated L1 cost function, the absolute difference between neighboring message components is bounded by a constant because

$$\begin{matrix}{m}^{n} ( q + 1 ) = {min}_{p} ( H ( p ) + V ( p , q + 1 ) ) \\ = {min}_{p} ( H ( p ) + V ( p , q ) + ( V ( p , q + 1 ) - V ( p , q ) ) ) ,\end{matrix} \qquad ( 3 )$$

which implies

mⁿ(q+1)≦mⁿ(q)+maxₚ(V(p,q+1)−V(p,q)) (4)

mⁿ(q+1)≧mⁿ(q)+minₚ(V(p,q+1)−V(p,q)). (5)

For truncated L1, we have

V(p,q)=min(k|p−q|,T) (6)

|V(p,q)−V(p,q+1)|≦k, (7)

where the parameter k is the gradient of the L1 function and T is the truncation threshold. Combining Eq. (4), (5) and (7) we get

|mⁿ(q+1)−mⁿ(q)|≦k (8)

By storing only the difference we could use fewer bits for each component. For example, a difference can be encoded using only 4 bits if the L1 gradient k≦7. The predictive coded message cn(q) can be written as:

cⁿ(q)=mⁿ(q+1−mⁿ(q), q=0, 1, 2 . . . (9)

We can apply the inverse transform to reconstruct the original message:

mⁿ(0)=0, mⁿ(q)=cⁿ(q−1)+mⁿ(q−1), q=1, 2, 3, . . . (10)

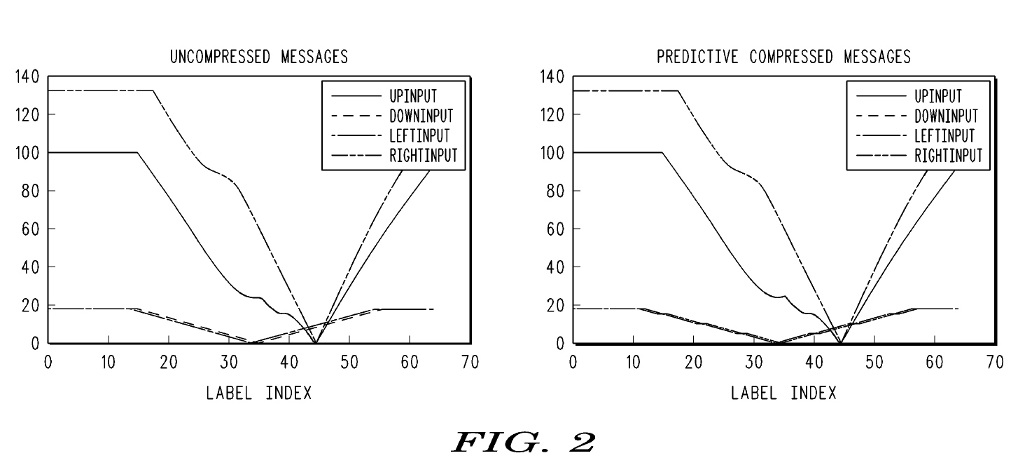

If the original message has already been quantized as integer numbers, then the coding scheme is lossless and we can perfectly reconstruct the signal by applying the inverse. Otherwise, errors are introduced after c(q) is quantized. FIG. 2 shows examples of reconstructed messages from predictive coding.

One advantage that arises from the use of a predictive coding scheme is that it preserves the minimal label, even after quantization. The minimal label can be defined as the label of the minimum message component. A message coding scheme preserves minimal labels if the minimal label of the original message is also the minimal label of the reconstructed message. Because the min-sum belief propagation algorithm selects the best label for each node by finding the minimum, any change in the minimal label by the new message representation will impact the performance of the belief propagation algorithm.

Another advantage arising from the use of a predictive coding scheme is that it is very efficient to implement and produces fixed length codes. Another important property of the predictive coding scheme is linearity, so linear operations on messages can be carried out directly on the compressed representations. Specifically for BP, the operation of adding three neighboring messages can be carried out without decoding. Furthermore, the coded messages can be packed into 32 bit integer format, which allows the use of a single 32 bit adder to process 8 message component adds, provided there is no overflow.

As previously mentioned, another type of compression scheme that may be used in the representation of a belief propagation message is a transform coding compression scheme. In transform coding the original signal (i.e., the belief propagation message) is projected onto a more compact basis that can preserve most of the signal's energy. Examples of transform coding compression schemes that may be employed include Principle Component Analysis (PCA) and Discrete Cosine Transform (DCT).

PCA, which is described, for example, in I. T. Jolliffe, “Principal Component Analysis” Springer-Verlag, New York, 1986, can be performed on the covariance matrix of the belief propagation messages. In principal component analysis, which is also known as eigen decomposition, the eigenvectors of the covariance matrix of all the messages are identified and the corresponding eigenvalues are noted. An eigenvector denotes a direction in the vector space and the eigenvalue denotes the amount of energy in a typical difference vector D in that direction. A subset of the eigenvectors define a subspace, such that any vector in the subspace is a linear combination of the eigenvectors in the subset. The amount of energy contained in this subspace is the sum of corresponding eigenvalues. Thus, the space can be decomposed into two sub-spaces or components such that one of them contains all the relatively large eigenvalues, which is called the Principal Component, and the other which is orthogonal to Principle Component, is called the orthogonal component.

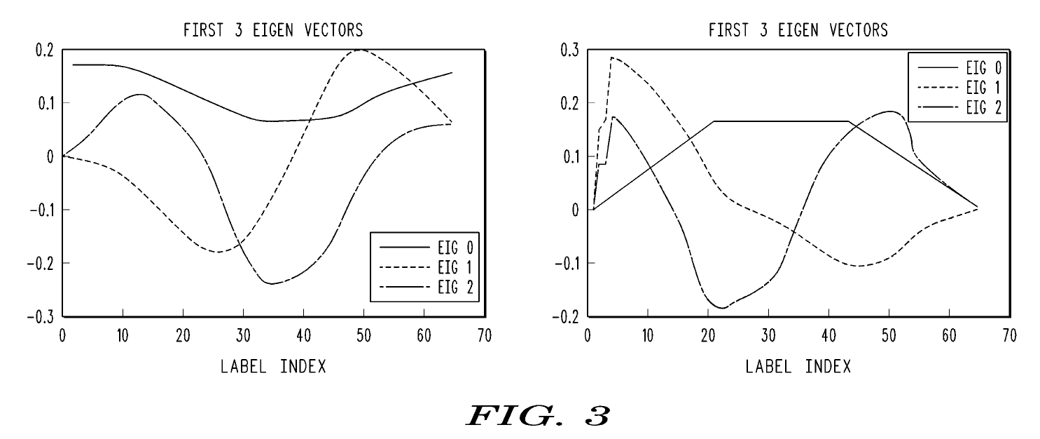

Experimental work has shown that many belief propagation messages are shifted versions of a basic “V” structure around the minimum. As shown in, B. J. Frey and N. Jojic. “Transformation Invariant Clustering Using the EM Algorithm,” IEEE PAMI, 25(1):1-17, January 2003, it is well known that a proper alignment can reduce the total variance of the data. We implemented an alignment scheme before applying PCA to circularly shift the message so that the minimum of the message vector is at the first component (Ties are broken arbitrarily.). The new representation is called Aligned PCA, which includes both a shift index and a set of PCA coefficients. Experiments show that Aligned PCA reduces the overall variance of the messages and gives better message approximations. FIG. 3 plots the first three eigenvectors of PCA and Aligned PCA obtained from the messages in a stereo image pair of a teddy bear taken from D. Scharstein and R. Szeliski, “High-Accuracy Stereo Depth Maps Using Structured Light,” cvpr, 01: 195, 2003.

In general, PCA does not guarantee that the minimal label of a message will be preserved, even with Aligned PCA. In BP, the messages are normalized to have minimum value 0, and Aligned PCA preserves the 0 value of the original minimal label. However, it is possible for the value of other labels in the reconstructed message to dip below 0 and shift the minimal label. This is because the eigenvectors can have both positive and negative components. PCA has a computational complexity of O(KN) where K is the number of eigenvectors used and N is the message length. This is higher than the O(N) cost of predictive coding, especially if K is large. PCA produces fixed length code and the compression ratio can be adjusted easily by selecting the number of principle components.

Yet another type of compression scheme that may be used in the representation of a belief propagation message is the nonlinear Envelope Point Transform (EPT). EPT can be embedded in the linear time minimum convolution algorithm proposed by Felzenszwalb and Huttenlocher (see P. Felzenszwalb and D. Huttenlocher, “Distance Transforms of Sampled Functions,” Technical Report TR2004-1963, Cornell University, 2004. and P. F. Felzenszwalb and D. P. Huttenlocher, “Efficient Belief Propagation for Early Vision,” Int. J. Comput. Vision, 70(1):41-54, 2006.) The EPT is based on the following observation: for the truncated L1 smoothness cost, if two samples of the aggregated message H(p) in Eq. (2) satisfy

H(a)>H(b)+k|a−b| (11)

then H(a) is completely masked by H(b) and has no effect in the lower envelope computed by the minimum convolution. This is because for any q the following inequality holds:

$$H ( a ) + \vert a - q \vert > ( H ( b ) + k \vert a - b \vert ) + k \vert a - q \vert > H ( b ) + k \vert b - q \vert \qquad ( 12 )$$

This implies that message components like H(a) can be removed and the lower envelope can still be reconstructed from H(b). Basically, an envelope point can be detected if its value is preserved during both forward and backward min. propagation. The algorithm to compute EPT preserves the linear time complexity and is outlined in FIG. 4. First, all points are denoted as non-envelope points. During forward propagation any label that preserves its value is denoted as an envelope point. Those envelope points that change value during backward propagation are then removed. The envelope points that remain are the desired envelope points.

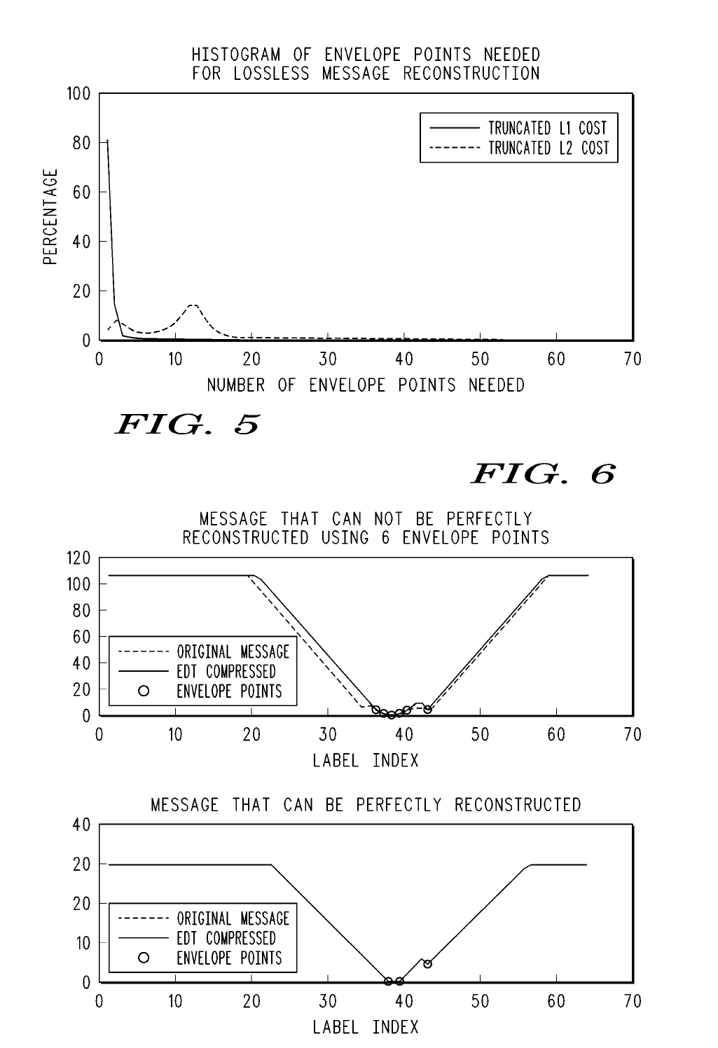

Given a sparse set of envelope points, one can reconstruct the original message by filling the rest of the message components with ∞, and applying the linear time minimum convolution algorithm. FIG. 5 shows a histogram of the number of envelope points needed to losslessly reconstruct the messages in the stereo image pair employed in FIG. 3. We can see that most of the messages can be reconstructed using a small number of envelope points. The average number of envelope points is 1.9, which yields 27× lossless compression. However, this compression ratio is possible only if variable length messages are allowed. In general, it is more advantageous if the representation of the messages have a fixed length so that dynamic memory allocation is not required for the compressed messages.

To meet the requirement of a fixed length code, cₙ can be set as an upper limit on the number of envelope points a compressed message could have. For those messages that need more envelope points than cₙ, we can keep only the cₙ points with the smallest magnitude. This approximation preserves the minimal label in the message and discards envelope points that are less likely to be the solution. The operation of selecting the cₙ smallest values can be applied in O(NlogN) time using heap sort, where N is the number of labels. But this is only necessary when cₙ is not enough to reconstruct the message. FIG. 6 shows two examples where a message can or cannot be losslessly reconstructed given a cₙ. According to the histogram in FIG. 5, only a small fraction of the total messages belongs to the second case.

A disadvantage of the envelope point transform is that it is nonlinear, so linear operations such as message addition cannot be carried out directly in the compressed domain. The advantage of the envelope point transform over predictive coding is that it can support a more gradual tradeoff between the compression ratio and quality by varying cₙ.

EPT is also not limited to L1 smoothness cost. The same concept can be extended to L2 smoothness cost. The aforementioned reference to P. F. Felzenszwalb and D. P. Huttenlocher in Int. J. Comput. Vision describes a linear complexity method for computing the minimum convolution with quadratic functions. That method can also be modified to detect the envelope points in the messages computed using the L2 smoothness cost. FIG. 5 plots the histogram of the number of envelope points needed to losslessly reconstruct the messages with L2 smoothness cost. The average number of envelope points needed is 11.6 for the stereo image pair. This means more envelope points are needed to represent a message, which is due to the faster growth rate of the quadratic functions.

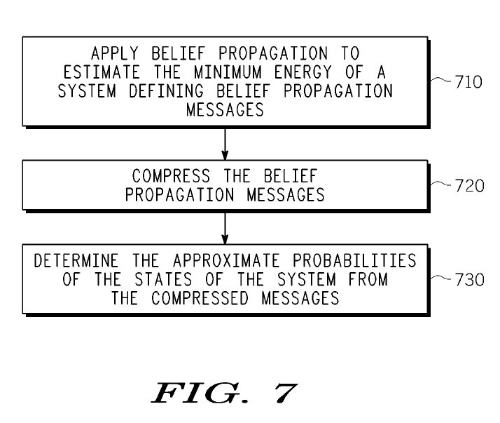

FIG. 7 shows one example of a method for determining the probabilities of states of a system that is represented by a model including a plurality of nodes connected by links. Each node represents possible states of a corresponding part of the system and each link represents statistical dependencies between the possible states of related nodes. The method begins in step 710 when a belief propagation algorithm is applied to estimate a minimum energy of the system defining belief propagation messages. Next, in step 720 the belief propagation messages are compressed using a technique such as transform coding, predictive coding and an envelope point transform technique, for example. Finally, in step 730 the approximate probabilities of the states of the system are determined from the compressed messages.

The processes described above may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. A method for determining probabilities of states of a system represented by a model including a plurality of nodes connected by links, each node representing possible states of a corresponding part of the system, and each link representing statistical dependencies between possible states of related nodes, comprising:
applying a belief propagation algorithm to estimate a minimum energy of the system defining belief propagation messages;
compressing the belief propagation messages; and
determining approximate probabilities of the states of the system from the compressed messages.

2. The method of claim 1 wherein a smoothness strength parameter employed in the belief propagation messages is truncated in accordance with an L1 cost function.

3. The method of claim 1 wherein the belief propagation messages are compressed using a transform coding technique.

4. The method of claim 3 wherein the transform coding technique is Principle Component Analysis (PCA).

5. The method of claim 4 further comprising circularly shifting each belief propagation message so that a minimum arises in a first component of an eigenvector that represents each belief propagation message.

6. The method of claim 4 wherein the transform coding technique is a Discrete Cosine Transform.

7. The method of claim 1 wherein the belief propagation messages are compressed using an Envelope Point Transform technique.

8. The method of claim 7 wherein a smoothness strength parameter employed in the belief propagation messages is truncated in accordance with an L2 cost function.

9. The method of claim 1 wherein the approximate probabilities are marginal probabilities.

10. The method of claim 1 wherein the belief propagation algorithm is a min-sum/max-product version of a belief propagation algorithm.

11. The method of claim 1 wherein the nodes and links are a Markov network representation.

12. The method of claim 1 wherein the nodes and links are a Markov network representation of an image

13. The method of claim 12 wherein the state probabilities that are determined represent intensity.

14. The method of claim 12 wherein the state probabilities that are determined represent disparity.

15. The method of claim 1 wherein the compressed belief propagation messages have a fixed code length.

16. The method of claim 1 wherein the belief propagation messages are compressed using a predictive coding scheme.

17. The method of claim 16 wherein the belief propagation messages are compressed into a 32 bit integer format.

18. At least one computer-readable medium encoded with instructions which, when executed by a processor, performs the method set forth in claim 1.

19. A method for reducing intramessage redundancy in belief propagation messages, comprising:
developing a plurality of belief propagation messages for a Markov network representation of a system; and
compressing the belief propagation messages.

20. The method of claim 19 wherein the belief propagation messages are compressed using a transform coding technique.

21. The method of claim 19 wherein the belief propagation messages are compressed using a predictive coding scheme.
